(19) United States
(12) Patent Application Publication
(10) Pub. No.: US 2001/0019337 A1
(43) Pub. Date: Sep. 6, 2001

(54) System for providing clients with a three dimensional virtual reality

(76) Inventor: Jong Min Kim, Seoul (KR)

Correspondence Address: Timothy J. Keefer, Wildman, Harrold, Allen & Dixon, 225 West Wacker Drive, Chicago, IL, 60606, US

(21) Appl. No.: 09/798,158

(22) Filed: Mar. 2, 2001

(30) Foreign Application Priority Data
Mar. 3, 2000 (KR) 2000-10593

(51) Int. Cl. G09G 5/00; G06F 15/16

(52) U.S. Cl. 345/757; 709/204

(57) ABSTRACT

A system provides clients with a three dimensional (3-D) virtual reality (VR) accessible via a network. The system receives a 3-D switching request from a client that is currently connected to a site providing two dimensional contents. In response to the request, it constructs a 3-D VR, wherein an image of the contents provided by the site is posted on the 3-D VR environment. Then, it allocates the constructed 3-D VR to the client and transmits the allocated 3-D VR to the client. The system enables users to view an image of 2-D contents provided by a 2-D site and simultaneously communicate with each other.

### BACKGROUND OF THE INVENTION

### RELATED APPLICATIONS

This application is related to “2-D/3-D WEB BROWSING SYSTEM” and “INFORMATION SEARCH SYSTEM BASED ON COMMUNICATION OF USERS”, which are co-pending U.S. applications Ser. Nos. ______ and ______, filed on Feb. 9, 2001 and Feb. 26, 2001, respectively, by the same applicant thereof and incorporated here by references.

1. Field of the Invention

The present invention relates generally to a system for providing three dimensional (3-D) virtual reality (VR) environments for users connected to a same network. More particularly, the invention relates to a system for providing a virtual reality environment that not only includes iconic gates linked to servers providing contents in a two dimensional (2-D) format but also captures and displays such two dimensional contents as part of the virtual environment.

2. Description of the Related Art

Recently, the rapid development of Internet related technologies have allowed navigation of the World Wide Web in a three dimensional environment. Specifically, a user controls the direction and movement of an avatar, the user's representative in the 3-D virtual reality, using a navigation controller provided in a 2-D/3-D web browser to navigate the web or communicate with other users. The avatar may be made to pass through iconic contents-gates having indices to access a web site linked to the index. If the avatar passes through a contents-gate, the user's client, his/her computer, gets connected to the web site and receives contents of the site for display on the screen. In other words, if the web browser running in the client detects an event or the entry of the avatar into contents-gate by monitoring the coordinates of the avatar in the VR environment. It transmits an event detection data to the server administrating the virtual environment. The server receives the detection data indicating that the avatar just passed and obtains the domain name of the site corresponding to the contents-gate. The server transmits the domain name to the client, whose browser, then, accesses the site using the received domain name and displays the contents of the site on the screen in a two-dimensional format.

Nowadays, there are 3-D-based web sites as well as more familiar 2-D-based ones in the Internet. Thus, if an avatar is controlled to pass through a contents-gate linked to a 2-D-based web site while navigating a 3-D environment, the 2-D/3-D web browser of the client automatically connects to the 2-D-based site and display its hypertext tiles on the screen. The user may return to the lasted-connected 3-D-based web site by clicking, for example, a navigation controller provided by the 2-D/3-D web browser that switches from the 2-D mode to the 3-D mode of web browsing.

When surfing in a 3-D environment, the user can better search for information by communicating with other users in the same 3-D virtual reality environment. On the other hand, no such interaction among users is possible in the conventional 2-D environment. That is, once the user passes through a contents-gate linked to a 2-D-based web site, the only communication means with other users who have access to the web is through conventional communication tool such as e-mail or chatting provided by the site. But it is not possible to identify who are concurrently connected to the web site despite that users who visit the same web site are likely to have a common interest. The communication or interaction among users who visit the same web site would help one to find desired information much fast and easily. Thus, it is desirable for a user to communicate with others who access the same 2-D-based web site.

Accordingly, a need exits for an enhanced technique for providing a 3-D virtual environment where users can view the contents provided by the currently-connected 2-D-based web site and simultaneously communicate with others concurrently connected to the same site.

### SUMMARY OF THE INVENTION

It is, therefore, a primary objective of the present invention to provide a system for allowing users to view a capture two dimensional content transmitted from a web site while communicating with others connected to the same web site.

It is another objective of the present invention to provide such communications among the users using avatars.

It is still another objective of the present invention to define capacity of a given 3-D virtual reality and to create another identical 3-D environment if the defined capacity is exceeded, to allocate the successive users after the capacity in the new 3-D environment.

It is further another objective of the present invention to provide a system for forming hexahedral 3-D virtual reality and displaying an image of the captured 2-D-based web page on one side of the hexahedral 3-D environment.

To accomplish the above objects, a system for providing clients with a 3-D VR accessible via a network is provided. The system comprises: means for receiving a 3-D switching request from a client that is connected to a site providing 2-D contents, means for constructing a 3-D VR, wherein an image of the contents provided by said site is posted on said 3-D VR environment, means for allocating the constructed 3-D VR to the client and means for transmitting the allocated 3-D VR to the client.

In accordance with the invention, the inventive system may further comprises means for providing communications between clients within the same 3-D VR, means for representing said client as an avatar in said 3-D VR and means for connecting the client to said site upon receiving a 2-D switching request from the client.

Furthermore, it is desirable that the allocating means allocates the same 3-D VR to some of other clients that are concurrently connected to said site. The 3-D VR may have the shape of a room with a captured image appearing on the wall of the room, the image being a portion of the contents received from the site. In addition, when the number of clients requesting 3-D switching request exceeds a predetermined number, the constructing means constructs another 3-D VR identical to the existing 3-D VR and the allocating means allocates the new 3-D VR to new clients requesting 3-D switching request.

Another purpose, features and advantages of the present invention can be easily understood from the following description. The advantages of the present invention will be made clear from the following description with respect to the figures, too.

### BRIEF DESCRIPTIONS OF THE DRAWINGS

The above and other objects and features of the present invention will become apparent from the following description of preferred embodiments given in conjunction with the accompanying drawings, in which:

FIG. 1 depicts a block diagram of an entire system including a server providing a 3-D VR in accordance with the present invention;

FIGS. 2A-2B depict flowcharts for describing sequentially procedure providing a 3-D VR in accordance with the present invention;

FIGS. 3A-3C depict exemplary screen displays tor explaining procedure visiting a 3-D VR in accordance with the present invention; and

FIG. 4 depicts a flowchart showing procedure of navigating a 3-D VR in accordance with the present invention.

### DETAILED DESCRIPTION OF THE PRESENT INVENTION

The present invention will now be described with reference to the accompanying drawings.

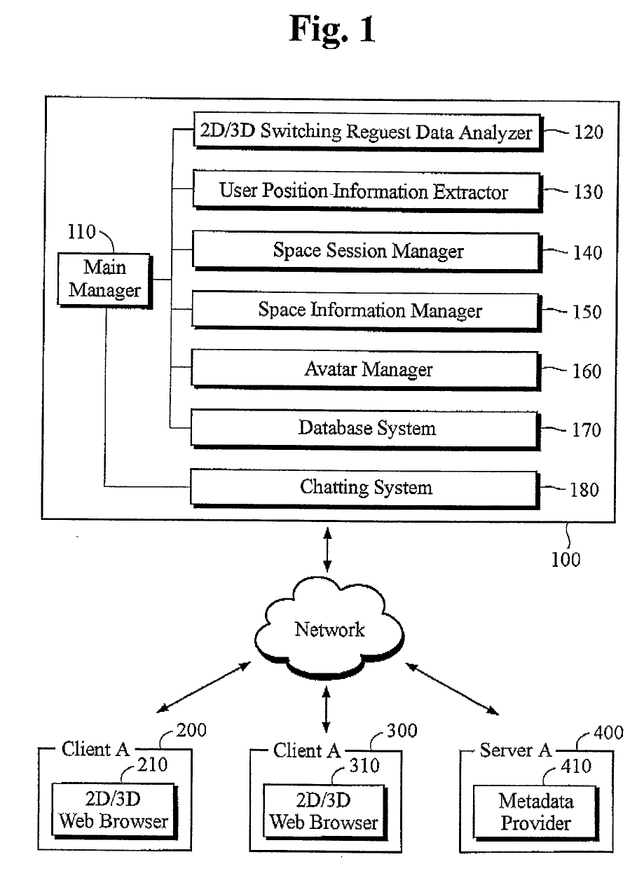

FIG. 1 shows a 3-D virtual reality (VR) server 100 and clients 200, 300, and a server 400 for providing hypertext information in a 2-D format.

The clients 200, 300, which are in reality computers connected to a communication network, each execute software called a browser 210, 310 to request hypertext information from servers also connected to the network. Preferably, the browser is of the type disclosed in “2-D/3-D WEB BROWSING SYSTEM” (U.S. patent application Ser. No. ______ filed on Feb. 9, 2001). However, any equivalent 2-D/3-D browser may be used at the clients. In the following, the description of the present invention will be made assuming that the 2-D/3-D web browser of the U.S. patent application is employed as the browsers of the clients. The browser comprises a user interface such as 2-D/3-D switchable window, a 2-D/3-D switching button, a navigation controller, a chatting history window, a user ID display window. Moreover, the browser comprises software routines that process a user input. The software routines include a 2-D/3-D switching input detector, a contents-tag event detector, a projection angle coordinator, a browser common control engine, etc. The 2-D/3-D switching input detector detects a 2-D/3-D switching input entered by the user via the 2-D/3-D switching button. It, then, forms a 2-D/3-D switching request data packet including user's ID, client's IP address, the URL of currently-connected site for transmission to the VR server system 100. The contents-tag event detector detects whether a contents-tag event has occurred and informs the VR server system 100 of the occurrence of a contents-tag event. The contents-tag event detector determines that the avatar has passed through a contents-gate if the coordinates of the avatar are within the contents-tag. The projection angle coordinator calculates the perspective of the avatar seeing the VR environment and transmits it to the VR server 100, which responds by transmitting back the VR description data according to the perspective. Thus, users can view a VR environment from different angles on their screens, depending on the positions of their representative avatars. The browser common control engine determines if data received from a server 400 is in a 2-D or 3-D format and executes the 2-D browser engine or 3-D browser engine based on the result of the determination. Aforementioned user interface and other components of the 2-D/3-D web browser are described in the U.S. patent application Ser. No. ______ filed on Feb. 9, 2001 in detail and thus will not be further discussed herein.

The server A 400 provides hypertext-written contents in a 2-D format. It comprises a meta data provider 410 for transmitting meta data to browser 210, 310 before transmitting the hypertext data. The meta data provider 410 provides meta data for the browser so that the browser can determine if the contents of the server is in a 2-D or 3-D format. It must be understood that the server A 400 represents servers on the network that are linked to the iconic contents gates of the VR environment.

The functions of each component of the VR server 100 of FIG. 1 are now explained. It comprises a main manager 110, a 2-D/3-D switching request data analyzer 120, a user position information extractor 130, a space session manager 140, a space information manager 150, an avatar manager 160, a database system 170 and a chatting system 180. The 2-D/3-D switching request data analyzer 120 analyzes a request received from the browser 210, 310 to determine whether it calls for 2-D/3-D switching. If so, it forwards the request to the main manager 110. The user position information extractor 130 extracts the user's ID, client's IP address and currently-connected site's URL from the 2-D/3-D switching request data received from main manager 110. The space session manager 140 has three functions: generating a new VR, establishing a VR session and allocating it to a user and managing the session capacity. The space session manager 140 captures the web page of a site which a user concurrently visits. It also generates a new VR, which is in the shape of hexahedron. In accordance with one aspect of the present invention, the page-captured image is put on one side of the VR. Optionally, an exit for leaving a site may be disposed on another side of the VR. The exit has a function similar to that of contents-gate. In other words, if an avatar passes through an exit in the VR, a user may move to a given site linked to the exit. Hence, implementation of the exit is similar to that of the contents-gate. The space session manager 140 checks whether a VR session for the currently-connected site (or site's URL) Is established or not. If a VR session was already established, the space session manager 140 allocates the session to the user. If not, it forms a new VR for the site's URL, establishes a session for the new VR and allocates the new VR session to the user. It also monitors the number of users allocated to a session. If the number exceeds a predetermined capacity, it generates another VR for the same URL, establishes a new session for the new VR and allocates the new session to the user. For example, if the capacity of a VR is set to 20 users, the 21st user attempting to access the VR will be provided with a new VR and be allocated to a session for the new VR. It is desirable that the capacity of a session should dynamically be set taking into account the visiting frequency to the VR, the sizes of avatars, communication between users in the VR, etc. For example, too many avatars in a VR will bring about a traffic jam, making it difficult to communicate with each other without a hitch. The space information manager 150 manages environmental information for each avatar's location, movement and motion in a VR. For example, it updates the background image of a VR depending on the movements of avatars and transmits this changed background information to all users in the VR. The avatar manager 160 manages the creation, deletion and modification of avatars in a VR based on input from users. The database system 170 saves data which are outputted and need to be processed again in future by aforesaid processors. The chatting system 180 forms a chatting channel among users in the same VR. It may be of the conventional chatting system. Preferably, both the conventional chatting system and “the INFORMATION SEARCH SYSTEM BASED ON COMMUNICATION OF USERS” (U.S. patent application Ser. No. ______ filed on Feb. 26, 2001) may be used as the chatting system 180, wherein the invention provides a technique that lets users help each other to procure 2-D/3-D information.

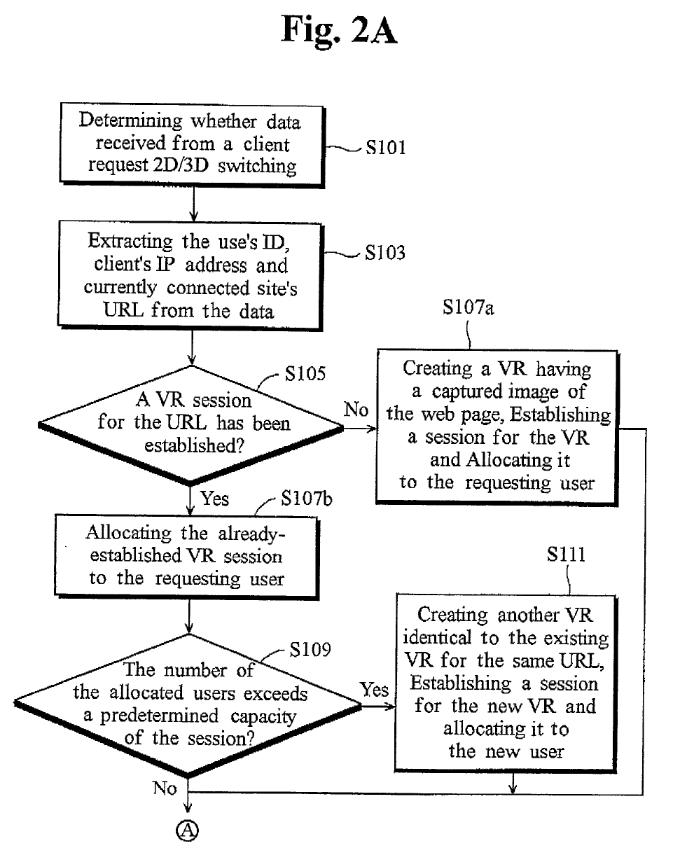

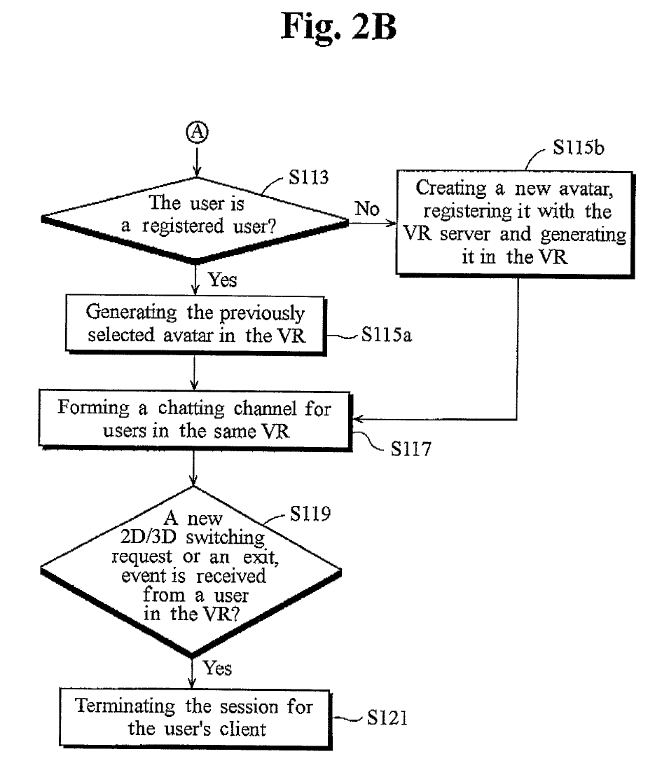

The procedure that the VR server system provides a VR in accordance with the present invention will now be discussed with reference to the flowcharts of FIGS. 2A-2B.

Fist of all, the 2-D/3-D switching request data analyzer under control of the main manager determines whether data received from a client request 2-D/3-D switching (Step S101). If 2-D/3-D switching is requested, the request is sent to the user positioning information extractor by the main manager. The client's IP address, the currently connected site's URL, etc. are extracted from the 2-D/3-D switching request data by the user positioning information extractor (Step S103). Next, the currently connected site's URL is sent from the user positioning information extractor to the space session manager, which examines whether a VR session for the URL has been established or not (Step S105). If no VR session for the URL is in progress, the space session manager creates a VR having the web page of the site corresponding to the URL. The captured image of the web page may be displayed in any place of the new VR. For instance, the captured image can be displayed as if it were hung on the wall of a room-like VR. The session for the new VR is established and allocated to the requesting user (Step S107a). If a VR session for the URL was already established and in progress, it is allocated to the requesting user (Step S107b). The space session manager examines whether the number of the allocated users exceeds a predetermined capacity of the session every time a new user is added to an on-going session (Step S109). If the capacity is exceeded, it creates another VR identical to the existing VR for the same URL. Then, a session for the new VR is established and allocated to the new user (Step S111). Next, the avatar manager determines whether the user is a registered user by checking the client IP address (Step S113). In the case of a registered user, the previously selected avatar, which has been saved in database system in the VR server, is generated in the VR (Step S115a). otherwise, the user selects one out of sample avatars. Alternatively, the user may build an avatar using an avatar creator software or an avatar-editing tool. An avatar may be automatically assigned to the user. The avatar creator software enables the user to choose and edit the appearance of an avatar to suit his/her favorite style. The user registers his/her own avatar with the VR server. Once an avatar is registered, it is displayed in the VR (Step S115b). Next, a chatting channel is formed for users in the same VR so that they can communicate with each other (Step S117). If a new 2-D/3-D switching request or an exit event is received from a user in the VR (Step S119), the space session manager terminates the session for the user's client. The avatar of the user will disappear from the VR. Then, the space session manager asks the 2-D contents server, to which the user was connected prior to the connection to the VR, to restart to send the 2-D web page to the user. In response, the user's client activates the 2-D browser engine to display the hypertext file being transmitted from the 2-D site (Step S121).

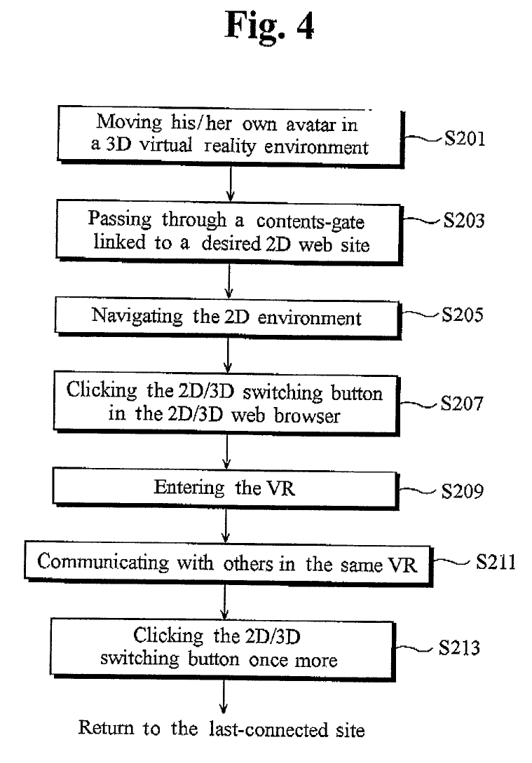

The exemplary procedure that a user navigates a VR provided by a VR server system in accordance with the present invention will now be discussed with reference to the flowchart of FIG. 4.

A user moves his/her own avatar in a 3-D virtual reality environment (Step S201) The 3-D VR environment includes contents-gates, which respectively are linked to other web sites, which are mostly servers providing contents in a 2-D format or could be another VR servers. The user visits a desired 2-D web site by controlling his/her own avatar to pass through a contents-gate linked to the 2-D web site (Step S203). Then, the user views hypertext-written 2-D contents provided by the web site (Step S205) and he/she Carl navigate the 2-D environment. If the user need help from others who are visiting the same site, he/she clicks the 2-D/3-D switching button in the 2-D/3-D web browser (Step S207). The user now enters the VR (Step S209). When the user enters the VR, the registered avatar for the user is generated in the VR if he/she is a registered user. A new user would have to set up an avatar before taking advantage of the salient features of a 3-D VR environment. Then, the image of the currently-visited web page may be displayed as if hung on the wall of the VR if the VR was designed to look like a room or office. In addition, the user can see not only his/her own avatar but also others' avatars in the same VR, At the same time, the user can communicate with the others using the chatting window (Step S211). The user may click the 2-D/3-D switching button once more in the 2-D/3-D web browser or pass through the exit in the VR if he/she wants to leave the VR. By doing this, he/she returns to the last connected 2-D-based site with the 2-D browser activated to display the page in the familiar 2-D environment (Step S213).

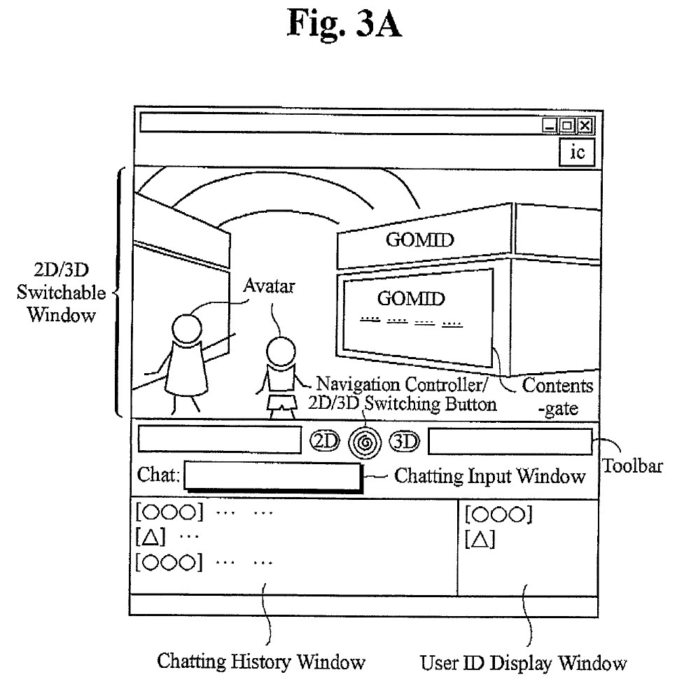

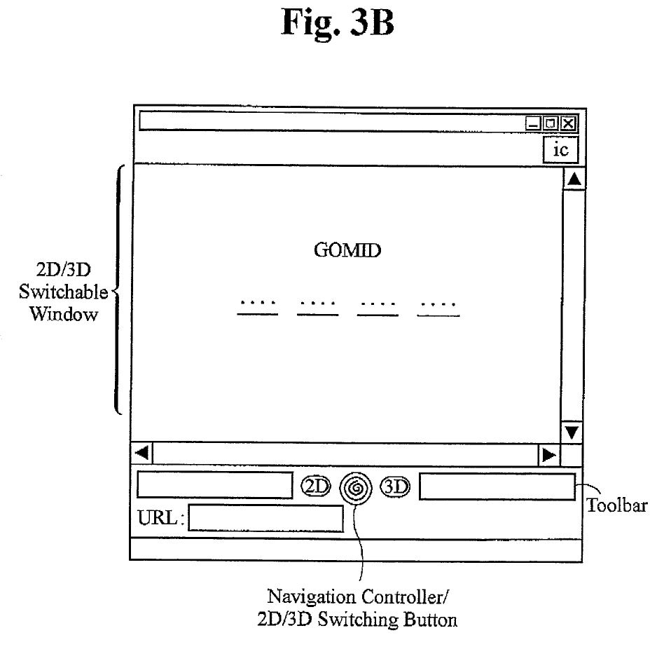

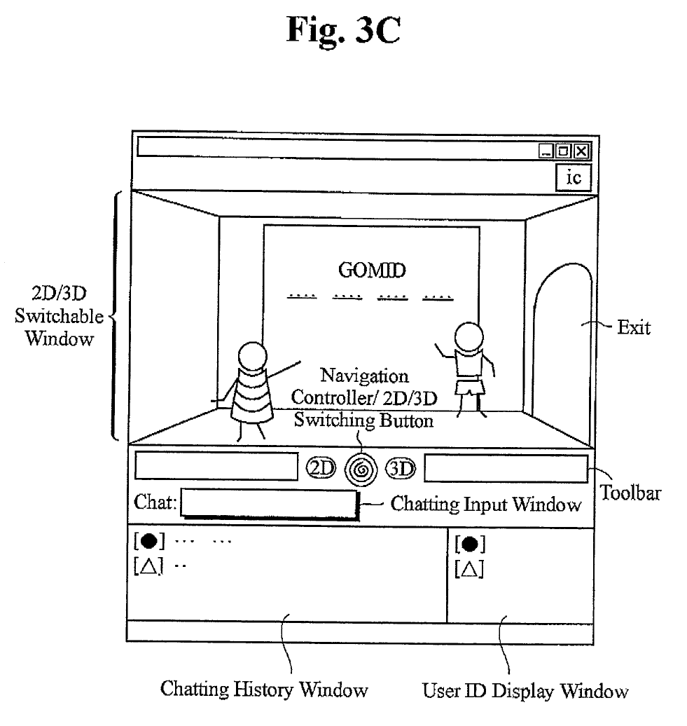

FIGS. 3A-3C are exemplary screen displays for the procedure of entering a VR provided by a system in accordance with the present invention. FIG. 3A shows an avatar standing in front of a contents-gate, led by another avatar in a VR. As shown in the drawing, the contents-gates have indices corresponding to web sites, shown as signboards, after the user's avatar passes through a contents-gate, the 2-D contents of the site linked to the contents-gate are displayed in the conventional 2-D browser window, as shown FIG. 3B. The user may click the 2-D/3-D switching button in the 2-D/3-D browser go back to the VR to display the web page of the visited site within the VR environment. The web page may be shown as if it were hung on the wall of the room-like VR, as shown in FIG. 3C. The users who visited the same site and selected the 2-D/3-D switching button are represented by avatars in the VR. In the same VR, a user can communicate with other users.

The 2-D formatted contents from a web site may be displayed in the following ways. First, using the 2-D browsing mode from the beginning, the content, i.e., hypertext files in the case of the World Wide Web, from the web site can be displayed. Secondly, in the case of browsing the network in a 3-D virtual reality environment, the user is automatically connected to a web site linked to a contents-gate that the avatar enters and receives the hypertext files in the 2-D mode. When the user next switches back to the 3-D mode by clicking on a switching button, for example, the VR server provides the user with the 3-D virtual reality in which the image obtained by capturing the current hypertext file is shown as “hanged” as mentioned earlier. Thirdly, the VR server may display the content of the 2-D-based web site linked to a contents-gate that the avatar just passed through. Specifically, when it receives an indication that the avatar just passed through a contents-gate then it directly access the 2-D web site and captures its content in order to display an image of the content in the current 3-D virtual reality environment. The VR server can determine whether the accessed web site provides content in a 2-D format by looking into the meta data it receives from the web site. When it receives an indication that the avatar exited from the web site from the client it restores the original 3-D environment. If the user wants to navigate the web site in the 2-D browser mode, by toggling a 2-D/3-D switching button for example, the VR server actives the execution of the 2-D browsing mode in the client so that the user now can navigate the web site in the conventional way. In other words, the third way of displaying the content of a web site linked to a contents-gate does not involve an operation by the user switching back to the virtual reality environment after he/she was connected to the web site.

While the present invention has been described and illustrated with respect to a preferred embodiment of the present invention, it will be apparent to those skilled in the art that variations and modifications are possible without deviating from the broad principles and teachings of the present invention which should be limited solely by the scope of the claims appended hereto.

What is claimed is:

1. A system for providing clients with a three dimensional (3-D) virtual reality (VR) accessible via a network, comprising:
means for receiving a 3-D switching request from a client that is connected to a site providing two dimensional (2-D) contents;
means for constructing a 3-D VR, wherein an image of the contents provided by said site is posted on said 3-D VR environment;
means for allocating the constructed 3-D VR to the client; and
means for transmitting the allocated 3-D VR to the client.

2. The system according to claim 1, wherein said allocating means allocates the same 3-D VR to some of other clients that are concurrently in connection with said site.

3. The system according to claim 2, further comprising:
means for providing communications between clients within the same 3-D VR.

4. The system according to claim 1, further comprising:
means for representing said client as an avatar in said 3-D VR.

5. The system according to claim 1, wherein said 3-D VR has the shape of a room and said image is posted on the wall of said room.

6. The system according to claim 1, wherein said image is obtained by capturing a portion of hypertext-written contents of said site.

7. The system according to claim 2, wherein when the number of clients requesting 3-D switching exceeds a predetermined number, said constructing means constructs another 3-D VR identical to the existing 3-D VR and said allocating means allocates said new 3-D VA to a new clients requesting 3-D switching request.

8. The system according to claim 1, further comprising:
means for connecting the client to said site upon receiving a 2-D switching request from the client.
